(19) United States
(12) Patent Application Publication
(10) Pub. No.: US 2015/0161158 A1
(43) Pub. Date: Jun. 11, 2015

(54) METHOD OF COMPRESSING COMPRESSION TARGET DATA, METHOD OF DECOMPRESSING DATA IN FILE, AND SYSTEM

(71) Applicant: FUJITSU LIMITED, Kawasaki-shi (JP)

(72) Inventor: Masahiro Kataoka, Tama (JP)

(21) Appl. No.: 14/625,980

(22) Filed: Feb. 19, 2015

Related U.S. Application Data
(63) Continuation of application No. PCT/JP2012/005299, filed on Aug. 23, 2012.

(51) Int. Cl. G06F 17/30

(52) U.S. Cl. CPC G06F 17/30153

(57) ABSTRACT

A method of compressing compression target data, includes: converting, by a processor, the compression target data into a compression code that is generated according to one of a first compression process and a second compression process corresponding to one of a first compression result and a second compression result where the compression target data is more compressed, based on the first compression result obtained when a first compression process is performed with respect to the compression target data, and the second compression result obtained when a second compression process is performed with respect to the compression target data, wherein the first compression process determines a code length based on information being obtained by converting the compression target data according to a predetermined algorithm and being different type from the compression target data, wherein the second compression process determines a code length based on the compression target data.

### CROSS-REFERENCE TO RELATED APPLICATION

This application is a continuation of International Application PCT/JP2012/005299, filed on Aug. 23, 2012, the entire contents of which are incorporated herein by reference.

### FIELD

The embodiments discussed herein are related to a data compression technology and a data decompression technology.

### BACKGROUND

Relating to a compression technology, a ZIP file format is known. In the ZIP, a compression algorithm which is referred to as LZ77, and a compression algorithm using Huffman codes are used together.

The LZ77 is a compression algorithm that generates compression codes by using repetition of data within a file of a compression target. That is, in the LZ77, a position (address within a slide window) where the data which matches the compression target data is previously appeared within the file, and a length (length of the longest matched data) of the matched data are generated. The longer the longest matched data length is, the more information is converted into one compression code. In the ZIP, it is determined that the conversion of the address within the slide window and the longest matched data length which are generated by the LZ77, is further performed. According to the conversion, each of the longest matched data length and the address within the slide window which are generated by the LZ77 and are included in the compression code, are converted into the compression codes of which code lengths are changed depending on their values.

On the other hand, in Huffman coding, the compression target data is converted into the compression code of which the length (code length) is determined depending on an appearance frequency of the compression target data. In the Huffman coding, a unit (such as a character code) of the data which is converted into the compression code, is determined in advance.

In the ZIP, depending on the value of the longest matched data length, the compression code is generated by switching the LZ77 and the Huffman coding. The switching of the compression algorithms is performed depending on the longest matched data length, and a threshold of the longest matched data length is determined as “3 (bytes)”. That is, in the ZIP, if the longest matched data length is 3 bytes or more, the LZ77 is used, and if the longest matched data length is less than 3 bytes, the Huffman coding is used.

Moreover, as described above, in the Huffman coding, with respect to a character or a sign which is represented by 1 byte, the compression code is assigned depending on the appearance frequency. In contrast, with respect to a word including a plurality of characters, the related art of assigning the Huffman code depending on the appearance frequency, is known.

As the related art, Japanese Laid-open Patent Publication No. 2012-142024, and “APPNOTE.TXT-.ZIP File Format Specification Version 6.2.0, Apr. 26, 2004, PKWARE Inc.” is known.

### SUMMARY

According to an aspect of the invention, a method of compressing compression target data, includes: converting, by a processor, the compression target data into a compression code that is generated according to one of a first compression process and a second compression process corresponding to one of a first compression result and a second compression result where the compression target data is more compressed, based on the first compression result obtained when a first compression process is performed with respect to the compression target data, and the second compression result obtained when a second compression process is performed with respect to the compression target data, wherein the first compression process determines a code length based on information being obtained by converting the compression target data according to a predetermined algorithm and being different type from the compression target data, wherein the second compression process determines a code length based on the compression target data; and outputting the compression code as a compression result of the compression target data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a process sequence example of a compression process based on a ZIP format;

FIG. 2A illustrates an example of a conversion table T1 of longest matched data lengths, and FIG. 2B illustrates an example of a conversion table T2 of addresses within a slide window;

FIGS. 3A, 3B, 3C and 3D illustrate an example of the data which is compressed based on the ZIP;

FIGS. 4A, 4B and 4C illustrate a conversion example of the address within the slide window;

FIG. 5 illustrates a configuration example of a functional block of a computer 1;

FIG. 6 illustrates a configuration example of a hardware of the computer 1;

FIG. 7 illustrates a configuration example of a program of the computer 1;

FIG. 8 illustrates a configuration example of devices in a system of an embodiment;

FIG. 9 illustrates an example of a correspondence table T3 of character codes and compression codes;

FIG. 10 illustrates an example of a correspondence table T4 of word codes and compression codes;

FIG. 11 illustrates a process sequence example of the compression process;

FIG. 12 illustrates an example of an index T5 of the correspondence table T4;

FIGS. 13A, 13B and 13C illustrate an example of the data which is compressed by this embodiment; and

FIG. 14 illustrates a process sequence example of a decompression process.

### DESCRIPTION OF EMBODIMENTS

According to the related art, a Huffman code is assigned to a word including a plurality of characters, and a code length of the Huffman code is determined depending on the word. Therefore, a compression algorithms in which a compression ratio of Huffman coding is improved by assigning the code to the word including the plurality of characters, and by assigning the code of the long length by a value of an address within a slide window of LZ77, the compression ratio of data becomes large (compression efficiency is not good) even when the longest matched data length is a threshold or more, may be selected.

An object of this embodiment is to improve the compression efficiency.

First, a compression process based on a ZIP format, will be described.

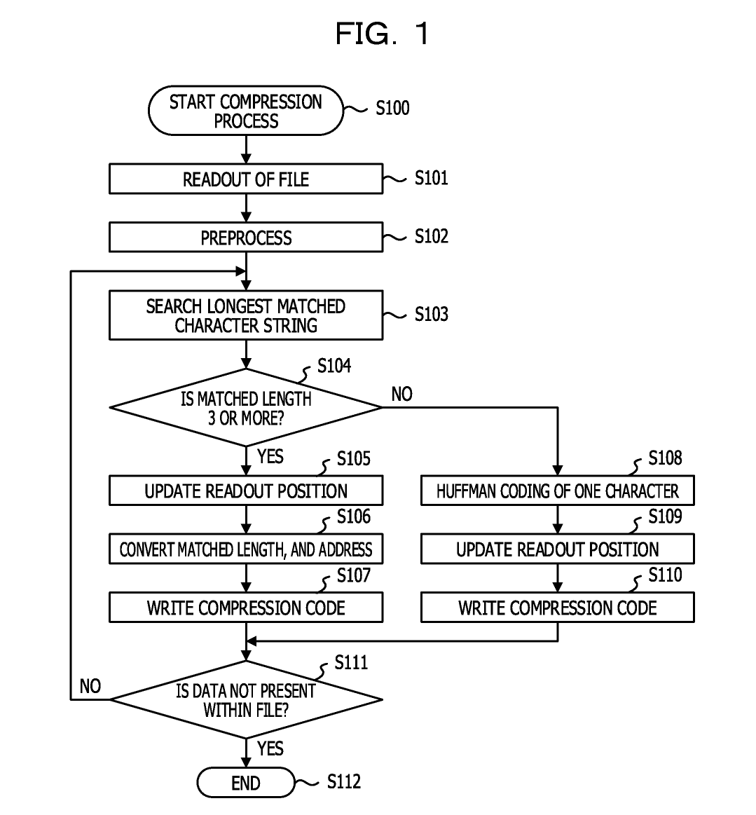

FIG. 1 illustrates a process sequence example of the compression process based on the ZIP format. A computer executes the sequence illustrated in FIG. 1, and thereby, a compression file according to the ZIP format is generated. If the compression of a certain file is instructed, a compression function is called (S100). If the compression function is called, the computer reads out the file to which the compression is instructed (S101). Next, the computer performs preprocesses such as generation of a Huffman tree which is used in the Huffman coding, a readout position of the compression target data, and setting of the slide window (S102).

After the process of S102, the computer performs a search of the longest matched character string of the compression target data, with respect to the data within the slide window (S103). Next, the computer determines whether or not the matched length of the longest matched character string which is seen in the process of S103 is 3 (bytes) or more (S104).

When the matched length of the longest matched character string is 3 or more (S104: YES), next, the computer updates the readout position of the compression target data, in accordance with the matched length of the longest matched character string (S105). In S105, a data range which is included in the slide window, is also updated. The computer performs the conversion again, with respect to the matched length which is obtained by the search in S103 and the address within the slide window (S106). In a compression code which is obtained by the conversion of S106, the code length is short as the value of the address is small, and the code length is long as the value is large. The computer writes the compression code which is obtained by S106 into a memory (S107).

When the matched length of the longest matched character string is less than 3 in the determination of S104 (S104: NO), the computer performs the Huffman coding, with respect to one character (1 byte) of the compression target data (S108). Furthermore, the computer shifts the readout position of the compression target data by one byte (S109), and updates the data range of the slide window. Still more, the computer writes the compression code which is obtained in S108 into the memory (S110).

If the compression code is written into the memory in S107 or S110, the computer determines whether or not the data to which the compression process is not performed, is present within the file (S111). When the data to which the compression process is not performed is not present in the determination of S111 (S111: YES), the computer ends the compression process (S112). On the other hand, when the data to which the compression process is not performed is present (S111: NO), the computer performs the process of S103 again. For example, the determination of S111 is performed based on whether or not the readout position of the compression target data is an end point of the file. In the first process and the second process of S103, since the data is not present within the slide window, the process of S104 is determined as NO.

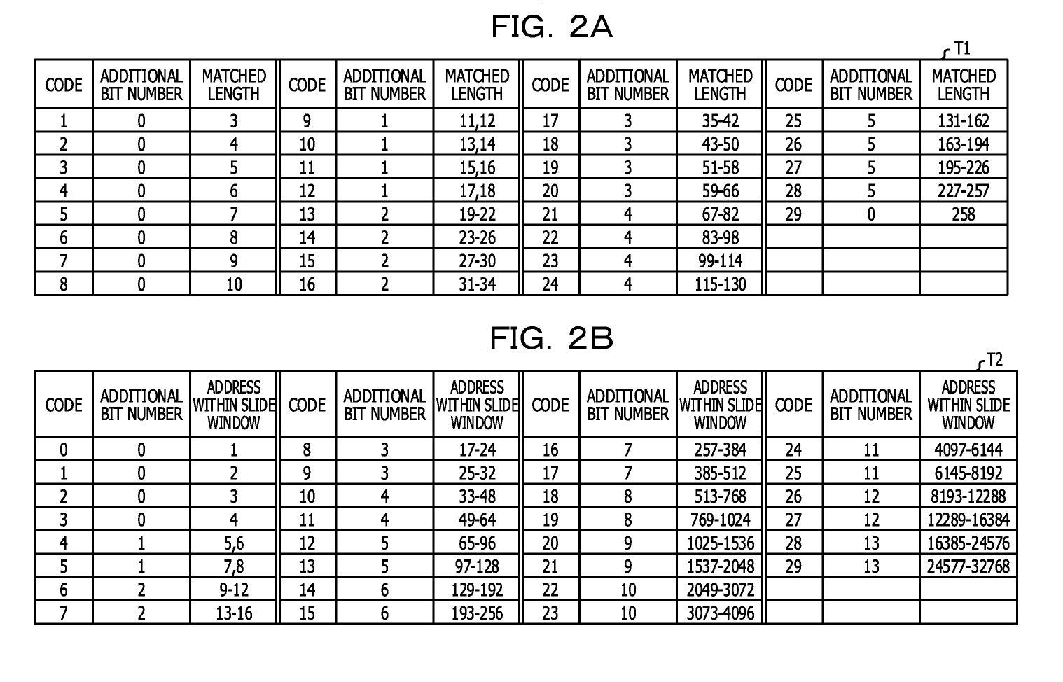

Next, the conversion of the matched length of the longest matched character string and the address which are performed by the process of S106 in FIG. 1, will be described. FIGS. 2A and 2B illustrate an example of a conversion tables T1 of the matched length of the longest matched character string, and a conversion table T2 of the address. FIG. 2A illustrates the conversion table T1 illustrating a code corresponding to the matched length and the number of additional bits. FIG. 2B illustrates the conversion table T2 illustrating a code corresponding to the address and the number of additional bits.

In the process of S106, the matched length is converted using any one of the codes of 29 types from “1” to “29” illustrated in FIG. 2A. For example, when the matched length is “3”, the matched length is converted into the code “1”. For example, when the matched length is “11”, the matched length is converted into the code “9”, and furthermore, one bit of the value “0” is added, and the matched length is represented by the code and the one additional bit. When the matched length is “12”, the code “9” is assigned, but one bit of the value “1” is added, and the matched length “11” and the matched length “12” are identified by a difference of the additional bit values. In the same manner, for example, if the matched length is “131”, the code “25” is assigned, and furthermore, 5 bits are added, and the matched length is represented by the code and the 5 additional bits.

In the same manner as the matched length, the conversion of the address within the slide window is performed by the process of S106. In the process of S106, the address within the slide window is converted into any one of the codes from “0” to “29” illustrated in FIG. 2B. In the same manner as the conversion of the matched length, when the value of the address is large, the additional bit is given to the code. For example, when the address within the slide window is “1”, the address is converted into the code “0”. For example, when the address within the slide window is “4097”, the address is converted into the code “24” and the 11 additional bits.

In all cases of the conversion using the conversion table T1 in FIG. 2A and the conversion using the conversion table T2 in FIG. 2B, the number of additional bits becomes large as the value before the conversion is large, and resultingly, the code length after the conversion becomes long. The code of the matched length which is obtained using the conversion table T1 in FIG. 2A, and the code of the address which is obtained using the conversion table T2 in FIG. 2B, are Huffman-coded, respectively. On the other hand, with respect to the additional bit, the Huffman coding is not performed.

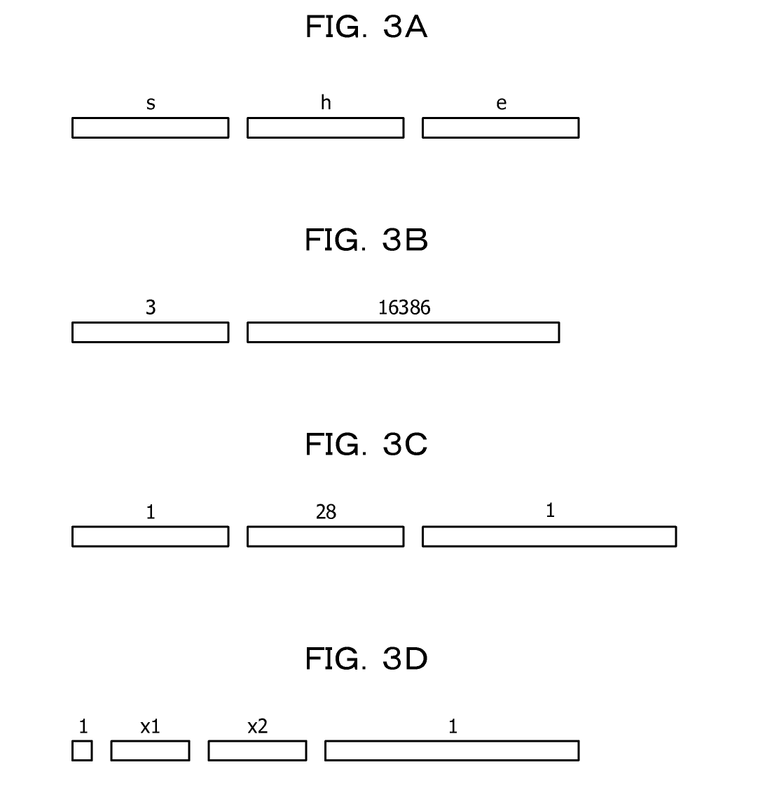

FIGS. 3A, 3B, 3C and 3D illustrate an example of the data which is compressed based on the ZIP format. FIGS. 3A, 3B, 3C and 3D illustrate the data of the compression process when the word “she” is obtained as a longest matched character string by the search of the longest matched character string of S103 in FIG. 1. When the data within the file of the compression target is represented using ASCII, each of the characters “s”, “h”, and “e” are represented by 8 bits, as illustrated in FIG. 3A. For example, if the matched length is “3”, and the address is “16386” in a search result of the longest matched character string of S103 in FIG. 1, the data illustrated in FIG. 3B is obtained. In each of the matched length and the address illustrated in FIG. 3B, if the conversion is performed using each of the conversion tables in FIGS. 2A and 2B, the data illustrated in FIG. 3C is obtained. The matched length “3” is converted into the code “1”, the code “28” is assigned to the address “16386”, and “1” is represented by the additional bits of 13 bits. If the code “1” indicating the matched length, and the code “28” indicating the address are further Huffman-coded, the data illustrated in FIG. 3D is obtained. In FIG. 3D, an identification code “1” indicating the compression code which is obtained using the LZ77, is given to a head of the data. In FIG. 3D, the code “1” of the matched length becomes “x1” by being Huffman-coded, and the code “28” of the address becomes “x2” by being Huffman-coded. That is, according to an example, the character string of “she” is converted into the compression code of 14 bits or more by the identification code and the additional bits, as illustrated in FIG. 3D. By the values of the Huffman codes “x1” and “x2”, the compression code becomes further long.

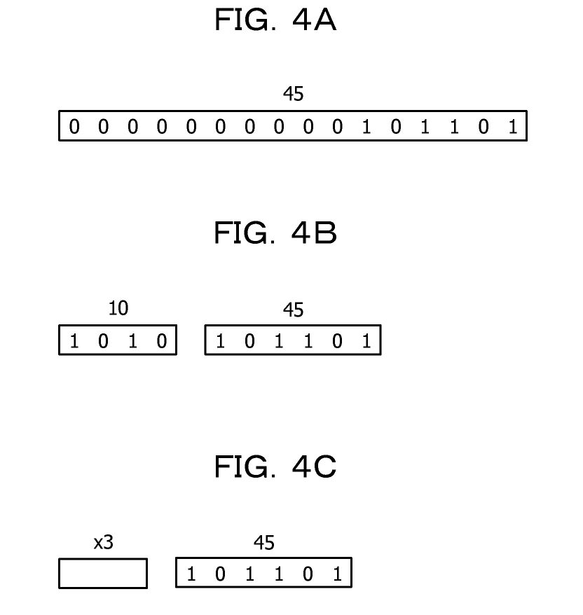

In the conversion of the address within the slide window, a method other than the method using the conversion table T1 in FIG. 2A, may be used. FIGS. 4A, 4B and 4C illustrate a conversion example of the address within the slide window. FIG. 4A illustrates an example of the address within the slide window. As illustrate in FIG. 4A, when the address within the slide window is “45”, the upper 10 bits among 16 bits indicating the address within the slide window, are consecutively “0”. FIG. 4B is an example in a case of representing the address illustrated in FIG. 4A, by the number of bits of which the values are consecutively “0” from the upper bit, and the remaining lower bits. In FIG. 4B, 10 bits which are consecutively “0”, are represented by 4 bits. Furthermore, an example of the result of performing the Huffman coding with respect to the number of bits of which the values are consecutively “0” from the upper bit, is illustrated in FIG. 4C. In FIG. 4C, the result of performing the Huffman coding to “10” in FIG. 4B, is illustrated as “x3”. Even when the methods illustrated in FIGS. 4A, 4B and 4C are used, if the value of the address within the slide window becomes large, the code length may be long.

As described above, in the compression according to the ZIP format, if the matched length is the threshold (3 bytes) or more, the compression algorithm that the code length is changed depending on the value of the address within the slide window, is used. Thereupon, depending on a size of the value of the address within the slide window, a situation where the code length of the compression code is longer than the case of simply performing the Huffman coding, may occur. In particular, if the address within the slide window becomes large, the code length of the compression code is likely to be longer. On the other hand, in the Huffman coding, the compression code is assigned to a character code (or a combination of character codes). Therefore, the code length of the compression code is determined depending on the character code.

This embodiment uses the compression algorithm by combining the compression algorithm that the code length of the compression code is changed based on information of the different type such as the character code, or the address within the slide window. Furthermore, this embodiment achieves reduction of the compression ratio, by selectively using a side where the compression ratio becomes small, among the compression codes which are generated by each of the compression algorithms.

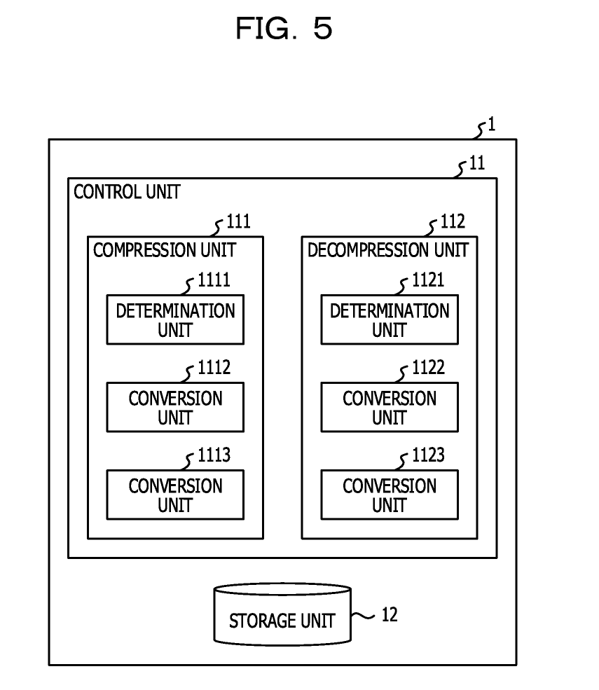

FIG. 5 illustrates a configuration example of functional blocks of a computer 1. The computer 1 includes a control unit 11, and a storage unit 12. The control unit 11 includes a compression unit 111, and a decompression unit 112. The compression unit 111 performs the compression process of a data file which is stored in the storage unit 12. That is, the compression unit 111 reads out the data file from the storage unit 12, and sequentially converts the data which is included in the read data file, into the compression codes. Therefore, the compression unit 111 sequentially stores the compression codes which are obtained by the converting in the storage unit 12, and generates the compression file. The decompression unit 112 performs a decompression process of the compression file which is stored in the storage unit 12. That is, the compression unit 111 reads out the compression file from the storage unit 12, and sequentially converts the compression codes which are included in the read compression file, into decompression data. Therefore, the compression unit 111 sequentially stores the decompression data which is obtained by the converting in the storage unit 12, and generates a decompression file.

The compression unit 111 includes a determination unit 1111, a conversion unit 1112, and a conversion unit 1113. The determination unit 1111 performs the determination as whether to convert the data into any one of the compression codes which are generated by the conversion unit 1112, and the compression codes which are generated by the conversion unit 1113, in the process of sequentially converting the data that is included in the data file which is read out from the storage unit 12 into the compression code.

The conversion unit 1112 generates the compression code based on a first compression algorithm. The conversion unit 1113 generates the compression code based on a second compression algorithm. At least one of the first compression algorithm and the second compression algorithm uses the compression code having a variable length. For example, in the first compression algorithm, depending on the size of the value of the data of the different type from the data within the data file that is obtained by converting the data which is read out from the storage unit 12, the code length of the compression code is changed. For example, the conversion unit 1112 performs the conversion based on the LZ77, with respect to the data which is read out from the storage unit 12. As a result of the conversion, the information which includes the address indicating the position where the conversion target data is previously appeared within the data file, is obtained, and the code length of the compression code which is used by the conversion unit 1112, is changed depending on the size of the value of the address. For example, the long code may be used as the value of the address is large, and the short code may be used as the value of the address is small.

For example, in the second compression algorithm, depending on the value of the data which is read out from the storage unit 12, the code length of the compression code is determined. For example, the conversion unit 1113 performs the Huffman coding, with respect to the data which is read out from the storage unit 12. In the Huffman coding, with respect to the value of the compression target data, since the code length and the compression code are assigned in advance depending on an appearance frequency, the code length of the compression code is determined based on the value of the data which is read out from the storage unit 12.

The determination unit 1111 calculates the compression ratios by each of the compression processes of the conversion unit 1112 and the conversion unit 1113, and determines whether the compression ratio of any one of the compression processes becomes better (becomes the small value). For example, the compression ratio is a numerical value indicating the size of the compression code with respect to the data before being converted into the compression code. The determination unit 1111 stores the compression code that is generated by the side of which the compression ratio becomes better among the conversion unit 1112 and the conversion unit 1113, in the storage unit 12. Furthermore, for example, the determination unit 1111 does not determine based on the compression ratio, and may determine based on the code length of the compression code. For example, the determination unit 1111 stores the compression code of which the code length is short, in the storage unit 12.

The determination unit 1111 also stores the identification code indicating the compression code which is generated by any one of the conversion unit 1112 and the conversion unit 1113, in the storage unit 12 in association with the compression code. For example, the determination unit 1111 gives the identification code “1” to the compression code which is generated by the conversion unit 1112, and gives the identification code “0” to the compression code which is generated by the conversion unit 1113.

The decompression unit 112 includes a determination unit 1121, a conversion unit 1122, and a conversion unit 1123. The determination unit 1121 determines whether to use the decompression data which is generated by any one of the conversion unit 1122 and the conversion unit 1123, based on the identification code that is given to the compression code which is included in the compression file. For example, if the identification code “1” is given to the compression code which is read out from the compression file, the determination unit 1121 uses the decompression data that is generated by the conversion unit 1122, and if the identification code is “0”, the determination unit 1121 uses the decompression data that is generated by the conversion unit 1123. The conversion unit 1122 performs the decompression process using a first decompression algorithm corresponding to the first compression algorithm. The conversion unit 1123 performs the decompression process using a second decompression algorithm corresponding to the second compression algorithm.

In the computer of the functional block configuration described above, the first compression algorithm and the second compression algorithm are used together. As described before, in the first compression algorithm, the code length of the compression code is changed depending on the size of the value of the address, and in the second compression algorithm, the code length of the compression code is determined with respect to the value of the compression target data. Since the value of the address within the slide window which is used by the LZ77 and the value of the compression target data do not have a correlation with each other, regardless of the size of the value of the compression target data, the value of the address may be the large value. If the value of the address becomes large, the code length tends to be long, and in such a case, the value of the compression ratio may become small in the second compression algorithm. By using the first compression algorithm and the second compression algorithm having the characteristics described above together, the compression efficiency is improved, that is, the target data is compressed into the compression data of a smaller data amount.

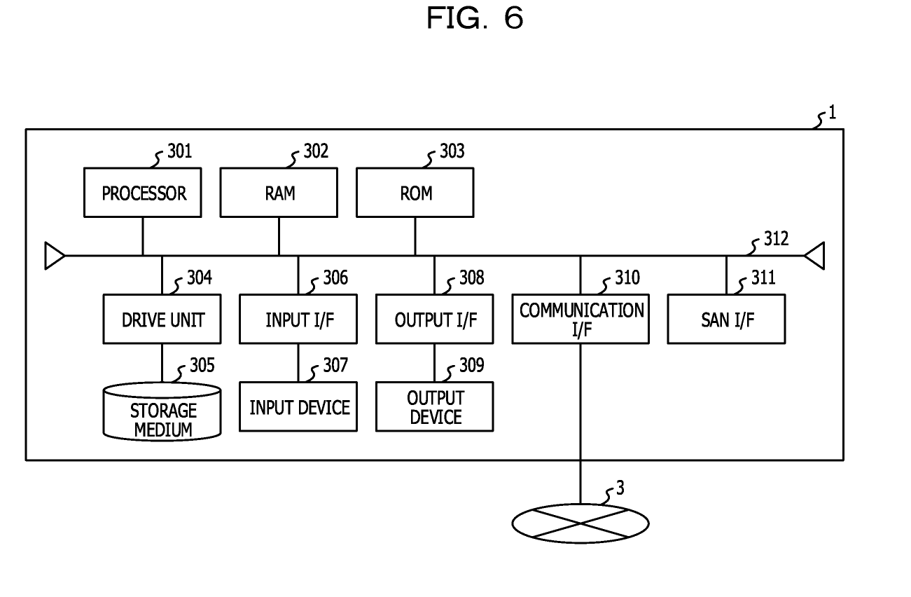

FIG. 6 illustrates a hardware configuration example of the computer 1. For example, the computer 1 includes a processor 301, a random access memory (RAM) 302, a read only memory (ROM) 303, a drive unit 304, a storage medium 305, an input interface (I/F) 306, an input device 307, an output interface (I/F) 308, an output device 309, a communication interface (I/F) 310, a storage area network (SAN) interface (I/F) 311, and a bus 312. Each of the hardware is coupled through the bus 312.

The RAM 302 is a readable and writable memory device. For example, a semiconductor memory such as a static RAM (SRAM) or a dynamic RAM (DRAM), or a flash memory even though not being the RAM, is used. The ROM 303 includes a programmable ROM (PROM) or the like. The drive unit 304 is a unit that performs at least any one of reading and writing of the information which is recorded in the storage medium 305. The storage medium 305 stores the information which is written by the drive unit 304. For example, the storage medium 305 is a flash memory such as a hard disk or a solid state drive (SSD), or a storage medium such as a compact disc (CD), a digital versatile disc (DVD) or a Blu-ray disc. Moreover, for example, the computer 1 may provide the drive unit 304 and the storage medium 305, with respect to each of the storage media of a plurality of types.

The input interface 306 is coupled to the input device 307, and transmits an input signal which is received from the input device 307, to the processor 301. The output interface 308 is coupled to the output device 309, and makes the output device 309 so that the output is executed depending on an instruction of the processor 301. The communication interface 310 performs a control of the communication through a network 3. The SAN interface 311 performs the control of the communication with a storage device through a storage area network that is coupled to the computer 1.

The input device 307 is a device that sends the input signal depending on an operation. For example, the input device 307 is a keyboard, a key device such as a button which is mounted on a main body of the computer 1, or a pointing device such as a mouse or a touch panel. The output device 309 is a device that outputs the information depending on the control of the computer 1. For example, the output device 309 is an image output device (display device) such as a display, or an audio output device such as a speaker. Additionally, for example, an input-output device such as a touch screen may be used as an input device 307 and an output device 309. Moreover, the input device 307 and the output device 309 are not included in the computer 1, and for example, may be devices which are coupled to the computer 1 from the outside.

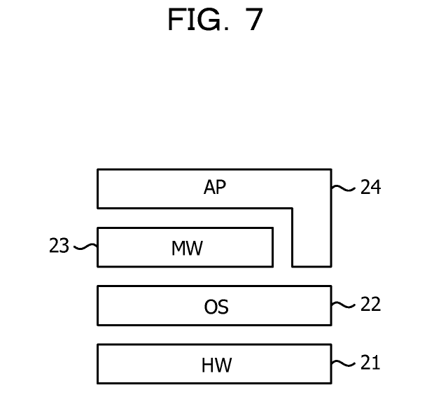

The processor 301 loads programs which are stored in the ROM 303 and the storage medium 305 onto the RAM 302, and performs the process of the control unit 11 according to the sequence of the loaded programs. At that time, the RAM 302 is used as a work area of the processor 301. The ROM 303 and the storage medium 305 store program files (such as an application program 24, a middleware 23, and an OS 22 described later) and the data files (such as the data file of the compression target, the compression file, the data file of a decompression target, and the decompression file), and the RAM 302 is used as a work area of the processor 301, and thereby, the function of the storage unit 12 is realized. The programs will be described using FIG. 7.

FIG. 7 illustrates a configuration example of the program of the computer 1. In the computer 1, the OS (operating system) 22 that performs the control of a hardware group 21 illustrated in FIG. 6, is operated. The processor 301 is sequentially operated according to the OS 22, and by performing the control and management of the hardware group 21, the process according to the application program 24 and the middleware 23 is executed in the hardware group 21. Furthermore, in the computer 1, the middleware 23 or the application program 24 is executed by the processor 301 which is loaded onto the RAM 302.

The processor 301 performs the process based on the compression function which is included in the middleware 23 or the application program 24 (performs the process by controlling the hardware group 21 based on the OS 22), and thereby, the function of the compression unit 111 is realized. Moreover, the processor 301 performs the process based on a decompression function which is included in the middleware 23 or the application program 24 (performs the process by controlling the hardware group 21 based on the OS 22), and thereby, the function of the decompression unit 112 is realized. The compression function and the decompression function may be respectively incorporated into the application program 24, or may be the functions of the middleware 23 which are executed by being called according to the application program 24.

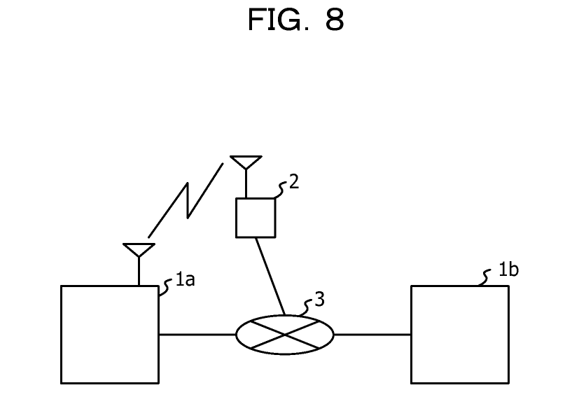

FIG. 8 illustrates a configuration example of devices in a system of the embodiment. The system of FIG. 8 includes a computer 1a, a computer 1b, a base station 2, and a network 3. The computer is coupled to the network 3 which is coupled to the computer 1b, by at least one of a wireless mode and a wired mode.

The compression unit 111 and the decompression unit 112 illustrated in FIG. 5, may be included in any one of the computer is and the computer 1b illustrated in FIG. 8. For example, in the system of FIG. 8, the computer is obtains the compression file in which the data file is compressed by the compression process of this embodiment in the computer 1b, and the computer is decompresses the compression file which is obtained from the computer 1b by the decompression process of this embodiment. That is, in this case, the computer 1b includes the compression unit 111 illustrated in FIG. 5, and the computer is includes the decompression unit 112. Additionally, for example, in the system of FIG. 8, the system may be configured such that the computer 1b obtains the compression file in which the data file is compressed by the compression process of this embodiment in the computer 1a, and the computer 1b decompresses the compression file which is obtained from the computer 1a by the decompression process of this embodiment. That is, in this case, the computer is includes the compression unit 111 illustrated in FIG. 5, and the computer 1b includes the decompression unit 112. Both of the computer is and the computer 1b may be provided with the compression unit 111 and the decompression unit 112.

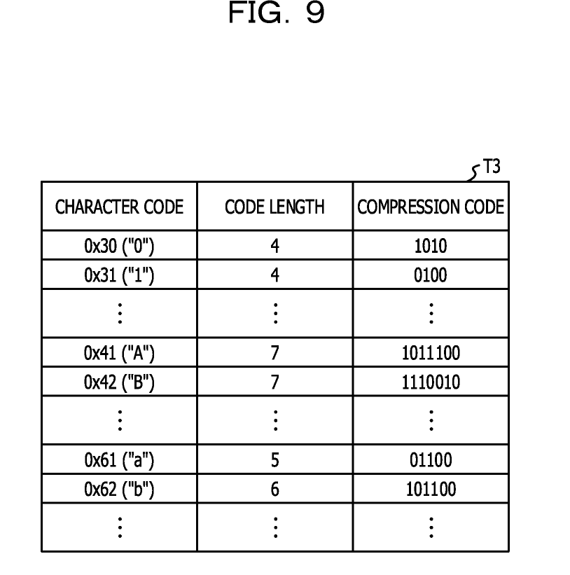

FIG. 9 illustrates an example of a correspondence table T3 of the character code and the compression code. In the correspondence table T3, the character code, the code length, and the compression code are associated with each other. For example, the compression code is determined based on the algorithm of the Huffman coding. The conversion unit 1113 converts the character code of the compression target into the compression code corresponding to the character code, with reference to the correspondence table T3.

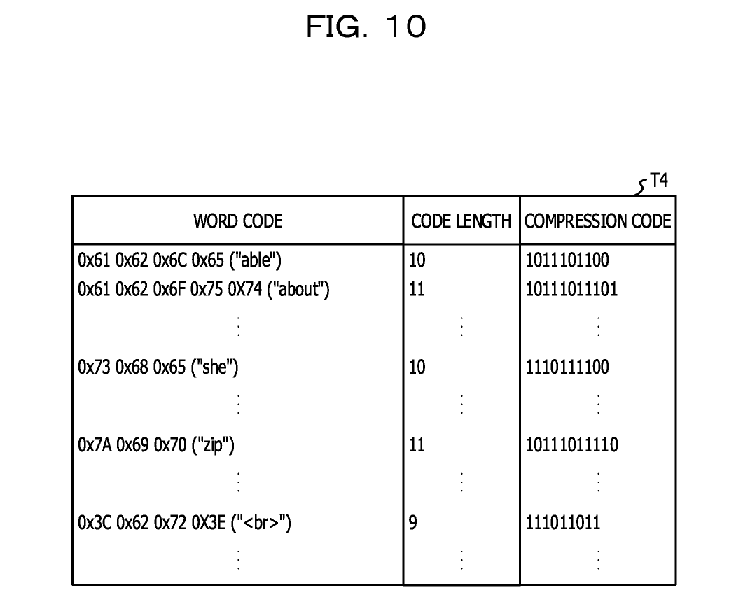

FIG. 10 illustrates an example of a correspondence table T4 of a word code and the compression code. In the correspondence table T4, the word code, the code length, and the compression code are associated with each other. The word code is a code in which the character codes of the respective characters included in the word are illustrated in order. The conversion unit 1113 converts the word code of the compression target into the compression code corresponding to the word code, with reference to the correspondence table T4.

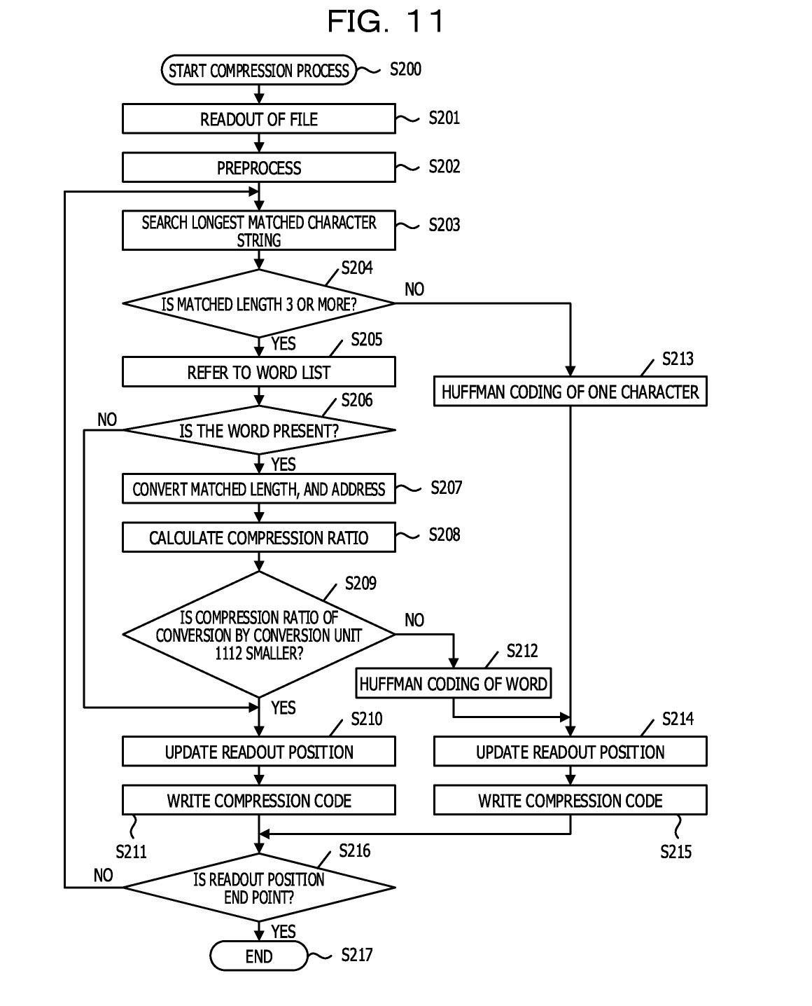

FIG. 11 illustrates a process sequence example of the compression process. If a compression instruction is performed with respect to the file, the compression function is called (S200). The compression unit 111 reads out the compression target file (S201). Next, the compression unit 111 reads out the correspondence tables T3 and T4, and performs the preprocesses such as an initial setting of the readout position of the data from the file and an initial setting of the slide window (S202).

If the process of S202 is completed, the conversion unit 1112 performs the search of the longest matched character string within the slide window (S203). Next, the determination unit 1111 determines whether or not the matched length which is obtained by the search of S203 is the threshold (3 bytes) or more (S204).

In the determination of S204, when the matched length is determined to be the threshold or more (S204: YES), the conversion unit 1113 refers to a word list (S205). For example, the word list is the correspondence table T4 illustrated in FIG. 10. The determination unit 1111 determines whether or not the character string which is read from the readout position of the compression target data is registered in the word list, depending on a reference result of the word list of S205 (S206). When a word corresponding to the read character string is present in the word list (S206: YES), the conversion unit 1112 converts the matched length which is obtained by the search of the longest matched character string in S203, and each address within the slide window (S207). For example, the conversion in S207 is performed based on the conversion tables illustrated in FIGS. 2A and 2B. Alternatively, the conversion unit 1112 may perform the conversion in S207 by using the conversion methods illustrated in FIGS. 4A, 4B and 4C. Furthermore, the determination unit 1111 calculates the compression ratio of the conversion by the conversion unit 1112, and the compression ratio of the conversion by the conversion unit 1113 (S208). Next, the determination unit 1111 compares the compression ratios which are calculated in S208, and determines whether or not the value of the compression ratio of the conversion by the conversion unit 1112 is smaller than the value of the compression ratio of the conversion by the conversion unit 1113 (S209).

When it is determined that the word corresponding to the read character string is not present in the word list in S206 (S206: NO), or when it is determined that the value of the compression ratio of the conversion by the conversion unit 1112 is small in S209 (S209: YES), the generation of the compression code is performed by the conversion unit 1112. That is, the conversion unit 1112 updates the readout position of the data of the compression target, depending on the matched length which is obtained in S203 (S210), and furthermore, writes the compression code which is obtained by the conversion in S207, into the memory (S211).

In S209, when it is determined that the value of the compression ratio of the conversion by the conversion unit 1112 is not small (S209: NO), the conversion unit 1113 obtains the compression code corresponding to the word which is found out in S205, from the correspondence table T4 (S212).

When the matched length which is obtained by the search in S203, is less than the threshold (3 bytes) (S204: NO), the conversion unit 1113 performs the Huffman coding with respect to the data (1 byte in the ASCII) of one character from the readout position of the compression target data in the compression target file (S213). In the process of S213, the conversion unit 1113 obtains the compression code corresponding to the character code (the data of one character) from the correspondence table T3.

If the compression code is obtained by the process of S212 or S213, the conversion unit 1113 performs the update of the readout position of the compression target data (S214). When the compression code corresponding to one character is obtained, the conversion unit 1113 advances the readout position by a degree of one character. On the other hand, when the compression code corresponding to the word is obtained, the conversion unit 1113 advances the readout position by the degrees of the number of characters of the word. Furthermore, the conversion unit 1113 writes the compression code which is obtained by the process of S212 or S213, into the memory (S215).

If the process of S211 or S215 is performed, the compression unit 111 determines whether or not the readout position which is updated by the process of S210 or S214, is the end point of the file. When the readout position is the end point of the file (S216: YES), the compression unit 111 ends the compression process by closing the data which is written into the memory as a compression file (S217). At the time of closing the file, the compression unit 111 also includes the information (such as the correspondence table T3 and the correspondence table T4) for generating the Huffman tree in the file. On the other hand, when the readout position is not the end point of the file (S216: NO), the process of S203 is performed again.

According to the sequence described above, among the compression algorithm that the code length is changed depending on the size of the value which is obtained by converting the compression target data, and the compression algorithm that the code length is determined by the value of the compression target data, the side of which the compression ratio is small, is adopted.

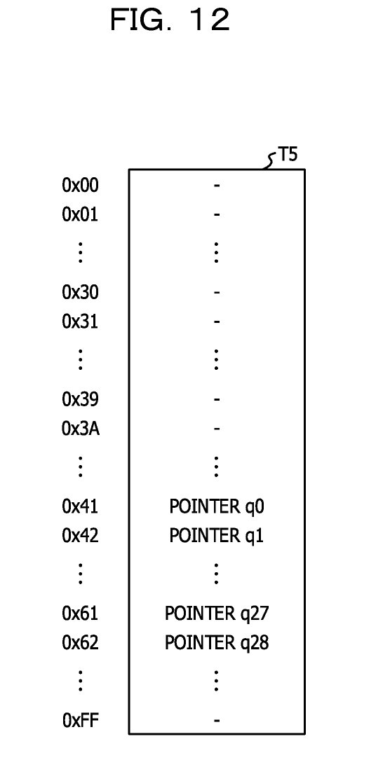

FIG. 12 illustrates an example of an index T5 of the correspondence table T4. In the process of S205 illustrated in FIG. 11, for example, the conversion unit 1113 refers to the correspondence table T4 by using the index T5 illustrated in FIG. 12. For example, the index T5 illustrated in FIG. 12, is stored in an area of storing a pointer of 16 bits by 256 types. For example, a pointer in which the first letter of the word in the correspondence table T4 indicates the position of the uppermost word among the words having the same first letter, is stored in the position corresponding to the character code of the first letter in the index T5. For example, when it is to be confirmed that the word beginning with “a” is registered in the correspondence table T4, the correspondence table T4 is referred, based on a pointer q0 which is stored from 97×16-th bit within the index information. The character code of “a” is 0x61, and is 97 by decimal number. Here, the size of each pointer is assumed to be 16 bits. For example, the pointer q0 indicates the position where the word code of “able” is stored in the correspondence table illustrated in FIG. 10. By using the index T5, it is possible to narrow the range of referring to the correspondence table T4, in the process of S205 illustrated in FIG. 11.

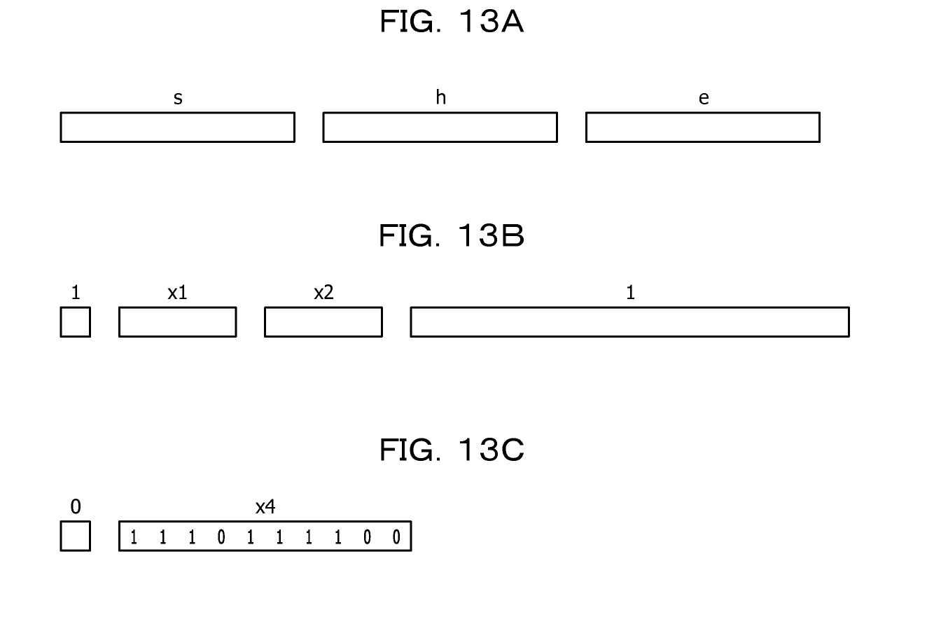

FIGS. 13A, 13B and 13C illustrate an example of the data which is compressed by this embodiment. FIG. 13A illustrates a state of the character string “she” before the compression. Each character is 8 bits, and the character string is 24 bits in total. FIG. 13B illustrates an example of the compression code which is generated by the conversion of the conversion unit 1112. The compression code illustrated in FIG. 13B, includes the identification code “1”, the Huffman code (x1) of the code of the matched length, the Huffman code (x2) of the code of the address within the slide window, and the additional bit (1) for representing the address within the slide window, in the same manner as FIG. 3D. Depending on the position where the longest matched character string is seen in the slide window, the number of bits which is used in the additional bit, is determined. FIG. 13C illustrates an example of the compression code which is obtained by the conversion of the conversion unit 1113. The compression code illustrated in FIG. 13C, includes the identification code “0”, and the compression code (x4) corresponding to the word “she” by the correspondence table T4. Since the Huffman code which is assigned to the word “she” is 10 bits, the code length of the compression code illustrated in FIG. 13C is 13 bits. Since the compression code illustrated in FIG. 13B asks for 13 bits into the additional bit for representing the address within the slide window, the compression code illustrated in FIG. 13C is shorter than the compression code illustrated in FIG. 13B, and the compression ratio thereof becomes small.

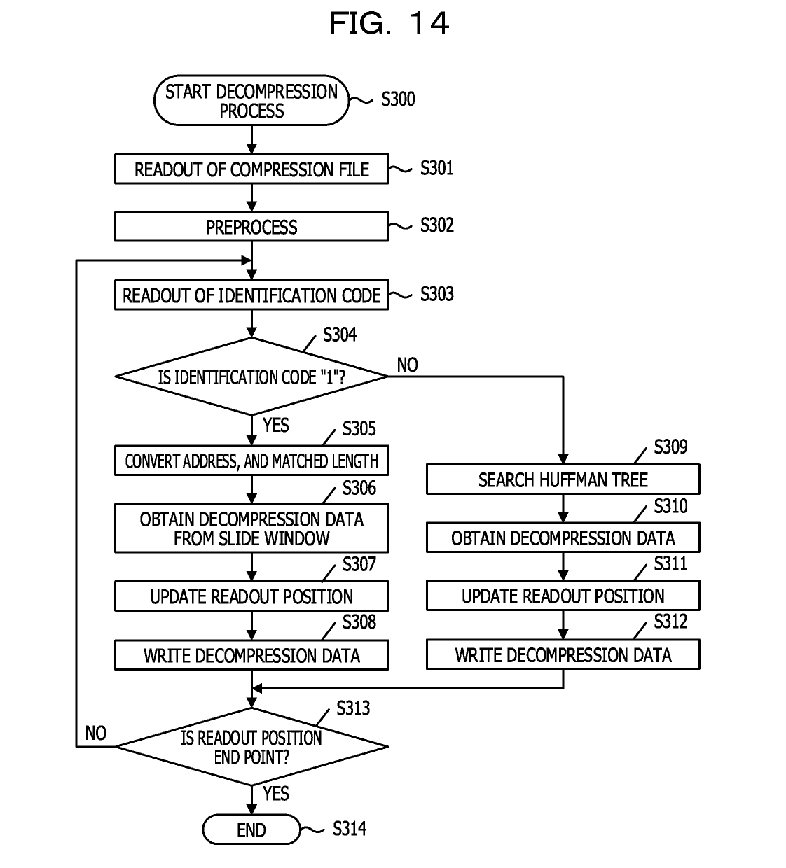

FIG. 14 illustrates a process sequence example of the decompression process. If the decompression is instructed with respect to the compression file, the decompression function is called (S300). The decompression unit 112 reads out the compression file which is stored in the storage unit 12 (S301). Next, the decompression unit 112 performs the preprocesses such as the initial setting of the readout position of the compression code from the compression file, the initial setting of the slide window, and the generation of the Huffman tree (S302).

The decompression unit 112 reads out the identification code of 1 bit from the readout position of the compression code (S303). The determination unit 1121 determines whether or not the read identification code is “1” (S304). When the identification code is “1” (S304: YES), the conversion unit 1122 executes the decompression process. On the other hand, when the identification code is “0” (S304: NO), the conversion unit 1123 executes the decompression process.

When the identification code is “1”, the conversion unit 1122 reads out the following compression code to the identification code from the compression file, and converts the read compression code into the address within the slide window, and the matched length (S305). The conversion unit 1122 obtains the decompression data from the slide window, based on the address within the slide window and the matched length (S306). Furthermore, the conversion unit 1122 updates the readout position from the compression file, depending on the read compression code (S307). In the process of S307, the update of the slide window is also performed together. Still more, the conversion unit 1122 writes the decompression data which is obtained by S306, into the memory (S308).

When the identification code is “0”, the conversion unit 1123 reads out the following compression code to the identification code from the compression file, and searches for the Huffman tree which is generated by S302, based on the read compression code (S309). By the search of the Huffman tree, the conversion unit 1123 obtains the decompression data corresponding to the compression code (S310). Furthermore, the conversion unit 1123 updates the readout position of the compression code, depending on the length of the read compression code (S311). The conversion unit 1123 writes the compression code which is obtained by S310, into the memory (S312).

If the process of S308 or S312 is executed, the decompression unit 112 determines whether or not the readout position of the compression code is the end point of the compression file (S313). When the readout position is not the end point of the compression file (S313: NO), the process of S303 is performed again. When the readout position is the end point of the compression file (S313: YES), the decompression unit 112 generates a file by the decompression data which is written into the memory according to the processes of S308 and S312, and ends the decompression process (S314). The processes of S307 and S308 described above may be reversed in an execution order thereof. Moreover, the processes of S311 and S312, may be reversed in the execution order.

Next, a relationship between the number of character codes and words to which the compression codes are assigned, and the code length of the compression code, will be described. In the Huffman coding, the types of the compression codes increase as the number of targets to which the compression codes are assigned becomes large, and thus, the compression code tends to be long. For example, the compression codes of 4096 types may be used in accordance with the character codes and the words. When each of the character codes and the word are included in the file at an equal frequency, the compression code of 12 bits is respectively assigned thereto. When the appearance frequencies are not equal, the compression code which is shorter than 12 bits, is assigned to any one of the character codes and the words.

On the other hand, in the conversion using the first compression algorithm by the conversion unit 112, 13 bits is asked for the additional bit for representing the address within the slide window. Therefore, even if the Huffman codes are assigned to the character codes and the words of 4096 types, a situation that the compression code which is generated by the conversion unit 113 becomes short, may sufficiently occur. That is, if the Huffman code of which the code length is smaller than 13 bits (since the code of the matched length and the code of the address within the slide window are Huffman-coded, an actual value is 13 bits or more) is assigned, there is a possibility that the compression ratio becomes small by applying the embodiments described above.

When the longest matched character string of which the length is single word or more is seen in the slide window, since the amount of the data which is converted into one compression code become large, the compression ratio tends to be small. Since the compression code of the smaller compression ratio is adopted even in such the case, advantages according to the LZ77 is not lost.

The embodiments described above are an example, and may be appropriately modified within the scope of carrying out the embodiments. Moreover, well-known technologies are appropriately used to those skilled in the art, and more detailed contents of each process described above, may be obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of compressing compression target data, comprising:
converting, by a processor, the compression target data into a compression code that is generated according to one of a first compression process and a second compression process corresponding to one of a first compression result and a second compression result where the compression target data is more compressed, based on the first compression result obtained when a first compression process is performed with respect to the compression target data, and the second compression result obtained when a second compression process is performed with respect to the compression target data, wherein the first compression process determines a code length based on information being obtained by converting the compression target data according to a predetermined algorithm and being different type from the compression target data, wherein the second compression process determines a code length based on the compression target data; and
outputting the compression code as a compression result of the compression target data.

2. The method according to claim 1, wherein
the information includes a numerical value indicating a position of a portion which matches the compression target data within a specified range in a file including the compression target data, and a numerical value indicating a data length of the matched portion.

3. The method according to claim 2, wherein
the code length through the first compression process is determined such that the larger the numerical value indicating the position is, the longer the code length becomes.

4. The method according to claim 1, wherein
the compression target data indicates a character code or a combination of character codes.

5. The method according to claim 4, wherein
the second compression process assigns a compression code of a code length depending on each appearance frequency, to each of the character codes and the combination of the character codes.

6. The method according to claim 5, wherein
the code length of each compression code which is assigned to each of the character codes and the combination of the character codes, is smaller than a maximum value of the code length which is determined based on the information.

7. The method according to claim 1, further comprising:
generating compression data including the compression code which is obtained by converting the compression target data, and an identification code which indicates one of the first compression process and the second compression process through which the compression code is generated.

8. A method of decompressing data in a compression file, comprising:
reading out from the compression file an identification code indicating one of a first compression process and a second compression process, wherein the first compression process determines a code length based on information being obtained by converting a compression target data according to a predetermined algorithm and being different type from the compression target data, wherein the second compression process determines a code length based on the compression target data; and
determining, by a processor, based on the identification code, which one of a first decompression process corresponding to the first compression process and a second decompression process corresponding to the second compression process is to be executed with respect to a compression code which follows the identification code and which is included in the compression file.

9. The method according to claim 8, wherein
the information includes a numerical value indicating a position of a portion which matches the compression target data within a specified range in a file including the compression target data, and a numerical value indicating a data length of the matched portion.

10. The method according to claim 9, wherein
the code length through the first compression process is determined such that the larger the numerical value indicating the position is, the longer the code length becomes.

11. The method according to claim 8, wherein
the compression target data indicates a character code or a combination of character codes.

12. The method according to claim 11, wherein
the second compression process assigns a compression code of a code length depending on each appearance frequency, to each of the character codes and the combination of the character codes.

13. The method according to claim 12, wherein
the code length of each compression code which is assigned to each of the character codes and the combination of the character codes, is smaller than a maximum value of the code length which is determined based on the information.

14. A system comprising:
a first memory; and
a first processor coupled to the first memory and configured to:
input a compression target data,
convert the compression target data into a compression code that is generated according to one of a first compression process and a second compression process corresponding to one of a first compression result and a second compression result where the compression target data is more compressed, based on the first compression result obtained when a first compression process is performed with respect to the compression target data, and the second compression result obtained when a second compression process is performed with respect to the compression target data, wherein the first compression process determines a code length based on information being obtained by converting the compression target data according to a predetermined algorithm and being different type from the compression target data, wherein the second compression process determines a code length based on the compression target data, and
output the compression code as a compression result of the compression target data.

15. The system according to claim 14, wherein
the information includes a numerical value indicating a position of a portion which matches the compression target data within a specified range in a file including the compression target data, and a numerical value indicating a data length of the matched portion.

16. The system according to claim 15, wherein
the code length through the first compression process is determined such that the larger the numerical value indicating the position is, the longer the code length becomes.

17. The system according to claim 14, wherein
the compression target data indicates a character code or a combination of character codes.

18. The system according to claim 17, wherein
the second compression process assigns a compression code of a code length depending on each appearance frequency, to each of the character codes and the combination of the character codes.

19. The system according to claim 18, wherein
the code length of each compression code which is assigned to each of the character codes and the combination of the character codes, is smaller than a maximum value of the code length which is determined based on the information.

20. The system according to claim 14, wherein the first processor is configured to generate compression data including the compression code which is obtained by converting the compression target data, and an identification code which indicates one of the first compression process and the second compression process through which the compression code is generated.

21. The system according to claim 20, further comprising:
a second memory; and
a second processor coupled to the second memory and configured to:
read out from the compression data the identification code, and
determine, based on the identification code, which one of the first decompression process corresponding to the first compression process and the second decompression process corresponding to the second compression process is to be executed with respect to the compression code which follows the identification code and which is included in the compression data.
